(19) United States
(12) Patent Application Publication
(10) Pub. No.: US 2004/0114599 A1
(43) Pub. Date: Jun. 17, 2004

(54) Massive packet transmitter in wide area network and transmitting and receiving method thereof

(76) Inventors: Bin-Yeong Yoon, Daejeon (KR); Dong-Yong Kwak, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/686,242

(22) Filed: Oct. 14, 2003

(30) Foreign Application Priority Data
Dec. 16, 2002 (KR) 2002-80301

(51) Int. Cl. H04L 12/28; H04J 3/07; H04J 3/24; H04L 12/56

(52) U.S. Cl. 370/395.1; 370/473; 370/505

(57) ABSTRACT

A massive packet transmitter in a WAN (wide area network) . The transmitter includes: an encoder for segmenting packets for transmission through the WAN into messages having a predetermined length, encoding the respective segmented messages, adding a parity bit to each encoded message to make it into a codeword, and transmitting the codeword/ A decoder is used for receiving the codeword from the encoder through the WAN, correcting an error of the corresponding codeword, and removing a parity bit included in the corresponding codeword to recover the codeword to an original message. Errors generated when transmitting massive packets through the WAN are removed using a FEC method, and massive packets such as a IPv6 jumbogram can be used without errors in the WAN.

### CROSS REFERENCE TO RELATED APPLICATION

This application is based on Korea Patent Application No. 2002-80301 filed on Dec. 16, 2002 in the Korean Intellectual Property Office, the content of which is incorporated herein by reference.

### BACKGROUND OF THE INVENTION

(a) Field of the Invention

The present invention relates to a method for transmitting datagrams of IPv6 (Internet protocol version 6). More specifically, the present invention relates to a device and method for transmitting massive packets in a wide area network (WAN) for transmitting jumbograms for transmission of massive packet IPv6 data in the WAN.

(b) Description of the Related Art

The IPv6 is referred to as an IPng (IP next generation), and it is an IETF standard designed as a developmental set for improving the currently-used IPv4. The IPv6 supports the format of packets referred to as jumbograms having a maximum length of 4 GB (Giga bytes), so as to transmit massive packet data.

FIG. 1 shows a block diagram of a data format of the IPv6 jumbogram.

Referring to FIG. 1, the IPv6 jumbogram comprises an IP header field 101, a TCP/UDP header field 102, and a payload field 103 for receiving data of from 64 KB to 4 GB.

Since transmission of the above massive packets has a substantial error rate, it is difficult to transmit them without errors in the WAN, and accordingly, their usage is restricted to narrow area networks such as a LAN (local area network) or a SAN (storage area network.)

Hence, the massive IPv6 jumbograms for transmission of massive packets is not applied to the WAN.

### SUMMARY OF THE INVENTION

It is an advantage of the present invention to provide a device and method for transmitting massive jumbograms in a WAN for transmitting massive packets without errors through the WAN.

In one aspect of the present invention, a method for encoding massive jumbograms for transmission of packets and transmitting them in a WAN comprises: segmenting a jumbogram to be transmitted through the WAN into messages each having a predetermined length; sequentially encoding each segmented message, adding a parity bit to the message to be formed into a codeword, and transmitting the codeword through the WAN; determining whether the last message from among the segmented messages is less than a predetermined length; adding a padding bit to the corresponding last message to make the last message have a predetermined length when the last message is less than the predetermined length according to a determination result; and converting the payload length information included in the segmented packet into length information after being converted into a codeword.

It is determined by using payload length information of the corresponding packet whether the segmented last message is less than the predetermined length.

In another aspect of the present invention, in a method for receiving encoded massive jumbograms through a WAN, a method for receiving massive packets in the WAN comprises: receiving an encoded codeword through the WAN; determining whether an error has occurred in the received codeword, correcting the error when it is found, and removing a parity bit included in the error-corrected codeword to recover the codeword to an original message; and decoding the recovered message and recovering the decoded message to a massive jumbogram.

The determination of error occurrence and the error correction method employ a FEC (forward error correction) method.

Receiving the last codeword further comprises: determining whether an error has occurred in the received last codeword, correcting the error when it is found, and removing the parity bit to recover the codeword to a message; determining whether the corresponding last message has a padding bit, and removing the padding bit when it is found.

It is determined using payload length information of the corresponding packet whether the last message has a padding bit.

In still yet another aspect of the present invention, a massive packet transmitter in a WAN comprises: an encoder for segmenting packets for transmission through the WAN into messages having a predetermined length, encoding the respective segmented messages, adding a parity bit to each encoded message to make it into a codeword, and transmitting the codeword; and a decoder for receiving the codeword from the encoder through the WAN, correcting an error of the corresponding codeword, and removing a parity bit included in the corresponding codeword to recover the codeword to the original message.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a block diagram of a data format of the IPv6 jumbogram;

FIG. 2 shows a block diagram of a configuration for an IPv6 jumbogram transmitter in the WAN according to a preferred embodiment of the present invention;

FIG. 3 shows a block diagram of a data format of the jumbogram generated through an encoder of FIG. 2 according to a preferred embodiment of the present invention;

FIG. 4 shows an encoding flowchart for an IPv6 jumbogram transmission method in the WAN according to a preferred embodiment of the present invention; and

FIG. 5 shows a decoding flowchart for an IPv6 jumbogram transmission method in the WAN according to a preferred embodiment of the present invention.

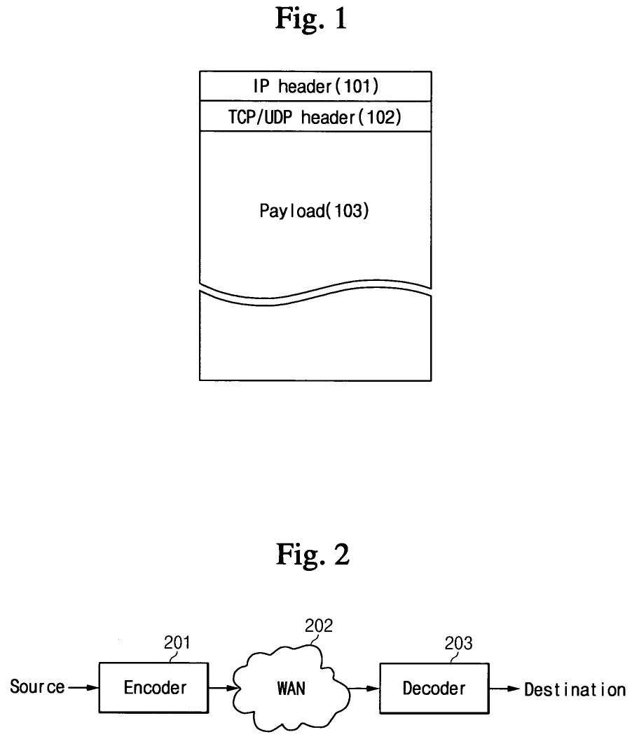

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

FIG. 2 shows a block diagram of a configuration for an IPv6 jumbogram transmitter in the WAN according to a preferred embodiment of the present invention.

Referring to FIG. 2, the IPv6 jumbogram transmitter comprises an encoder 201, a WAN 202, and a decoder 203.

The encoder 201 segments jumbograms to be transmitted into N messages each having a K-bit length, adds a parity bit to each segmented message to make it into a codeword, and transmits the codeword to a receiver side. K should be selected so that N is at least two and the length of each message is small enough to allow for error correction to be performed for each message. Thus, the size of K is typically determined by the error correction technique utilized.

In this instance, when the last message N lacks some bits from a predetermined bit length, the encoder 201 adds one or more padding bits to make the last message have a predetermined bit length K, and adds parity bits to the last message with the padding bits added to transmit results.

The decoder 203 receives the encoded jumbograms and decodes them into original packets.

The format of the jumbograms encoded by the encoder 201 will now be described.

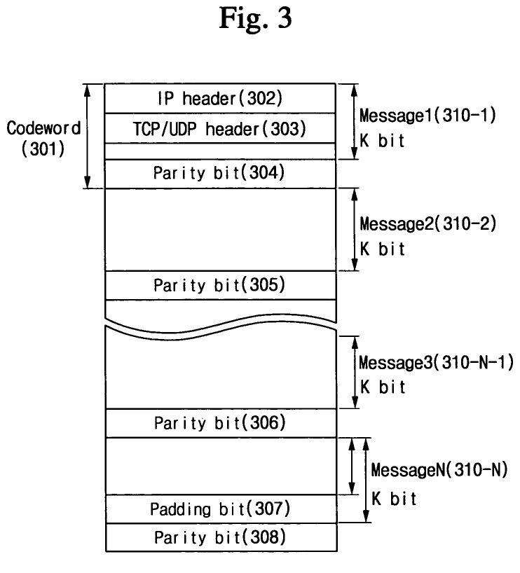

FIG. 3 shows a block diagram of a data format of the jumbogram generated through an encoder of FIG. 2 according to a preferred embodiment of the present invention.

Referring to FIG. 3, a jumbogram comprises N K-bit messages 310-1 through 310-N, a parity bit is added to each message to form a codeword 301, and the codeword 301 is then transmitted.

Since the last message 310-N may have a length less than the K bits because of a variable length of the jumbogram, padding bits are used so as to control it to have a predetermined length.

In this instance, in the first codeword case, a length of parity bits is also added to the jumbo payload length information provided in a jumbogram option field because the encoding is to be substituted with a calculated value.

The padding bits are dummy bits to make the length of the last message N 310-N be K bits.

A method for encoding the jumbogram will now be described.

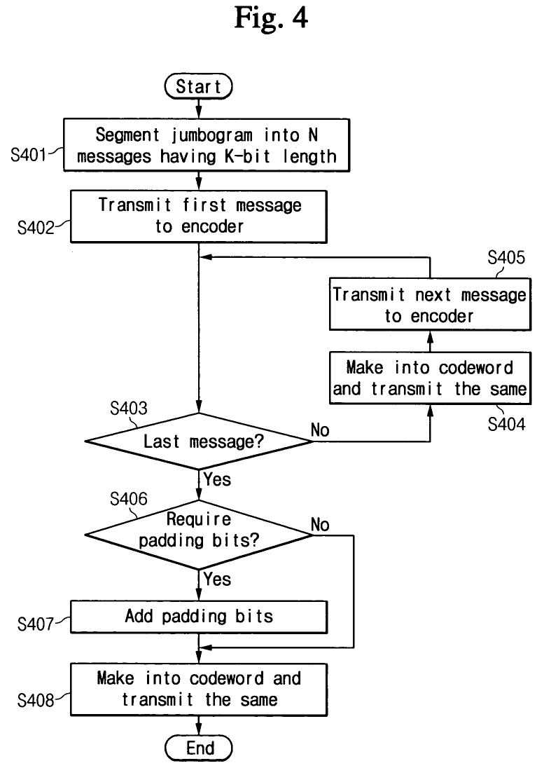

FIG. 4 shows an encoding flowchart for an IPv6 jumbogram transmission method in the WAN according to a preferred embodiment of the present invention.

Referring to FIG. 4, a jumbogram is segmented into N messages 310-1 through 310-N each having a predetermined K-bit length, and the messages are transmitted to the encoder 201 in step S401.

When the messages 310-1 through 310-N are sequentially provided to the encoder 201 in step S402, the encoder 201 determines whether a received message is the last message N in step S403, and when it is not the last one, the corresponding message is encoded with the BCH (Bose Chaudhuri Hochquenghem) code, a parity bit is added to it to generate a codeword, and the codeword is transmitted in step S404. The encoder 201 receives a next message in step S405 to generate a codeword, and transmits the codeword in step S404.

Also, when the message input to the encoder 201 is the last message N according to a determination result in the previous step S404, it is determined whether the message N is to have K bits to determine whether to add padding bits in step S406.

Therefore, when the last message N does not have a K-bit length, it is determined to add the padding bits, and accordingly, the padding bits are added to the corresponding last message N 310-N to make it have a K-bit length in step S407, and it is formed into a codeword and transmitted to the WAN 202 in step S408.

The codeword is input to the decoder 203 through the WAN 202 to be recovered to the original jumbogram.

A method for decoding the jumbogram by the decoder 203 will now be described.

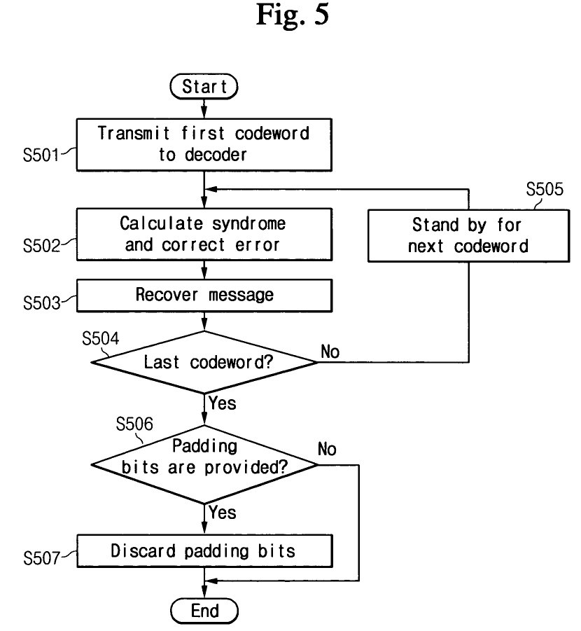

FIG. 5 shows a decoding flowchart for an IPv6 jumbogram transmission method in the WAN according to a preferred embodiment of the present invention.

Referring to FIG. 5, when receiving the first codeword through the WAN 202 in step S501, the decoder 203 calculates a syndrome of the first codeword, and when an error has occurred, the decoder 203 corrects the error using the syndrome in step S502.

The decoder 203 removes the parity bit included in the corresponding codeword to recover the original message in step S503, and determines in step S504 whether the recovered message is a codeword including the last codeword N 310-N using jumbo payload length information in the jumbogram option field included in the first codeword.

When it is not the last codeword according to a determination result, the decoder 203 stands by for receipt of a next codeword in step S505, and when receiving the next codeword, the decoder 203 recovers the original message through the previous steps S502 and S503.

Also, when it is the last codeword according to the determination result, the decoder 203 determines whether the corresponding message includes padding bits in step S506, and when they are found, the decoder 203 discards them in step S507 to recover the message to a complete message.

As described above, since a transmitter side that follows the jumbogram transmitting method according to the preferred embodiment of the present invention segments massive packets into predetermined lengths, and encodes the respective segmented messages to transmit them through the WAN, and a receiver side receives the encoded messages and recovers them through the FEC (forward error correction) method, the massive packets are transmitted without errors through the WAN.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A method for encoding massive jumbograms for transmission of packets and transmitting them in a WAN (wide area network), comprising:
segmenting a jumbogram to be transmitted through the WAN into messages each having a predetermined length; and
sequentially encoding each segmented message, adding a parity bit to the message to be formed into a codeword, and transmitting the codeword through the WAN.

2. The method of claim 1, further comprising:
determining whether the last message from among the segmented messages is less than a predetermined length; and
adding at least one padding bit to the corresponding last message to make the last message have a predetermined length when the last message is less than the predetermined length according to a determination result.

3. The method of claim 2, wherein it is determined by using payload length information of the corresponding packet whether the segmented last message is less than the predetermined length.

4. The method of claim 1, further comprising converting the payload length information included in the segmented packet into length information after being converted into a codeword.

5. In a method for receiving encoded massive jumbograms through a WAN (wide area network), a method for receiving massive packets in the WAN, comprising:
receiving an encoded codeword through the WAN;
determining whether an error has occurred in the received codeword, correcting the error when it is found, and removing a parity bit included in the error-corrected codeword to recover the codeword to an original message; and
decoding the recovered message and recovering the decoded message to a massive jumbogram.

6. The method of claim 5, wherein the determination of error occurrence and the error correction method employ a FEC (forward error correction) method.

7. The method of claim 5, wherein receiving the last codeword further comprises:
determining whether an error has occurred in the received last codeword, correcting the error when it is found, and removing the parity bit to recover the codeword to a message;
determining whether the corresponding last message has at least one padding bit, and removing the at least one padding bit when it is found.

8. The method of claim 7, wherein it is determined using payload length information of the corresponding packet whether the last message has at least one padding bit.

9. In a method for transmitting and receiving a massive jumbogram through a WAN (wide area network), a method for transmitting and receiving a massive packet in the WAN, comprising:
(a) segmenting a packet to be transmitted through the WAN into messages having a predetermined length;
(b) sequentially encoding the respective segmented messages, adding a parity bit to each of them, making the parity bit added message into a codeword, and transmitting the codeword; and
(c) receiving the transmitted codeword to determine whether an error has occurred in it, correcting the error when it is found, and removing a parity bit from the codeword to recover the codeword to an original message.

10. A massive packet transmitter in a WAN (wide area network) comprising:
an encoder for segmenting packets for transmission through the WAN into messages having a predetermined length, encoding the respective segmented messages, adding a parity bit to each encoded message to make it into a codeword, and transmitting the codeword; and
a decoder for receiving the codeword from the encoder through the WAN, correcting an error of the corresponding codeword, and removing a parity bit included in the corresponding codeword to recover the codeword to the original message.

11. The transmitter of claim 10, wherein the encoder adds at least one padding bit to the last message of the segmented packet to make the last message have a predetermined length when the last message is less than the predetermined length.

12. The transmitter of claim 10, wherein the decoder recovers the last codeword from among the codewords received through the WAN, determines whether at least one padding bit is provided, and removes the at least one padding bit when they are found.
